(19) United States
(12) Patent Application Publication
(10) Pub. No.: US 2008/0245775 A1
(43) Pub. Date: Oct. 9, 2008

(54) Method of automatically detecting the wear of a welding electrode

(75) Inventors: Thomas Opderbecke, Saint-Ouen L'Aumone (FR); Sebastien Gadrey, Gouloux (FR)

Correspondence Address: YOUNG & THOMPSON, 209 Madison Street, Suite 500, ALEXANDRIA, VA, 22314, US

(73) Assignees: L' AIR LIQUIDE SOCIETE ANONYME POUR L' ETUDE ET L' EXPLOITATION DES PROCEDES GEORGES CLAUDE, PARIS (FR); AIR LIQUIDE WELDING FRANCE, PARIS (FR)

(21) Appl. No.: 11/902,685

(22) Filed: Sep. 25, 2007

(30) Foreign Application Priority Data
Sep. 25, 2006 (FR) 06/53919

(51) Int. Cl. B23K 9/10; B23K 9/00

(52) U.S. Cl. 219/121.45; 219/130.5

(57) ABSTRACT

An automated method for detecting the wear of a non-consumable electrode of an arc welding torch and for automatically replacing or remachining the electrode when it is eroded with a fresh electrode includes the following steps: a) the number of strikes performed by the electrode in question, and possibly the arc time of the electrode and the strike time for establishing the arc, is measured or counted during welding; b) the value of at least one of the wear-indicating parameters determined in step a) is compared with at least one preset respective reference value; and c) the eroded electrode is replaced with a fresh or sharpened electrode when the value of at least one of the wear-indicating parameters is equal to or exceeds at least the preset respective reference value.

The invention relates to an automated method for detecting the wear of a non-consumable electrode of an arc welding torch, and for automatically replacing said electrode when it is eroded with a fresh electrode, and to an installation for implementing said method.

In TIG arc welding, a non-consumable tungsten electrode is regularly replaced with a fresh or sharpened electrode, since the worn electrode may, if it has deteriorated, disturb the striking or even the welding.

In manual welding, the electrode is replaced by the operator when he notices that it is no longer operating correctly or when he can see visually that it has deteriorated.

Robotizing or automating the TIG welding process entails anticipating and automating the change of the tungsten electrode in order to ensure reliable operation. This change must be accomplished without manual intervention and as quickly as possible so as not to impair the productivity of the process, in particular when it is incorporated into a production line.

Preferably, these electrode replacement interventions must be carried out in background time, that is to say advantageously during robot stoppage times.

In all cases, it is of paramount importance from the industrial standpoint to be able to prevent the production of poor-quality welds resulting from the use of a degraded electrode.

Thus, an electrode change may be performed preventatively, that is to say after a given operating time or a planned number of strikes.

However, such a preventative electrode change, that is to say a change made before its operating limit has been reached, has the disadvantage of there being inefficient use of the electrodes since some of them will be replaced prematurely, therefore possibly incurring additional costs.

In addition, it is not always possible or easy to define a maximum electrode lifetime precisely, which means that the time before change must be defined with a wide margin, and therefore the abovementioned risk of too early a replacement is increased.

Conversely, the electrode may be changed at the moment the electrode fails, that is to say after observation of a poor weld or a striking problem for example.

However, this has the disadvantage of producing defective parts, of stopping the machine for a certain time, and of requiring the constant presence of a nearby operator, who must immediately intervene in the event of an incident, thereby impairing the productivity of the process.

In resistance welding, a system is known for detecting the wear of the electrode, which is based on measuring the contact resistance of the electrode, and for starting a change cycle when this resistance becomes incompatible with effective welding. However, such a system is not suitable for the TIG process.

Moreover, document JP-A-63040683 describes a system for detecting the wear of an electrode for a resistance welding process, which provides for the electrode being changed after a defined number of welded parts. As mentioned above, this runs the risk of the electrode being replaced prematurely.

The problem to be solved is therefore how to provide an improved electrode wear detection method which can be entirely automated, that is to say does not require the intervention of an operator to decide when the electrode has to be replaced.

In addition, this method must prevent or minimize premature, or conversely belated, changes of the electrode of a non-consumable electrode torch mounted on a robot or an automatic welding machine.

One solution of the invention is therefore an automated method for detecting the wear of a non-consumable electrode of an arc welding torch and for automatically replacing or remachining said electrode when it is eroded with a fresh electrode, in which method the following steps are carried out:

a) the number of strikes performed by the electrode in question, and possibly at least one wear-indicating parameter chosen from the arc time of said electrode and the strike time for establishing the arc, is measured or counted during welding;

b) the value of at least one of the wear-indicating parameters determined in step a) is compared with at least one preset respective reference value; and

c) the eroded electrode is replaced with a fresh or sharpened electrode when the value of at least one of the wear-indicating parameters is equal to or exceeds at least said preset respective reference value.

Note:

“reference value”: no distinction should be made between an exact value or an average value, corresponding for example to a value measured at a given instant or averaged over a given time, or else a range of values; and

“fresh electrode”: no distinction should be made between an electrode that is completely fresh, and therefore has never been used, and an electrode that has been sharpened or repaired, after it has been used beforehand one or more times.

Depending on the case, the method of the invention may comprise one or more of the following features:

several of said parameters are determined and compared in step a) and the electrode is replaced when several of said parameters exceed their preset respective reference values;

in step a), the electrical current and/or voltage generated by said electrode over a given welding time is also determined;

in step b), the measured current and/or voltage variations are compared with preset current and/or voltage variation threshold values; and

in step c) the electrode is replaced when:

the value of at least one of the wear-indicating parameters is equal to or exceeds the preset reference value or

at least one of the voltage and/or current values exceeds one of the preset voltage and/or current threshold values;

the maximum number of strikes is set at 10 000 strikes, preferably 1000 strikes, more preferably 200 strikes;

the maximum strike time is 5 seconds, preferably 0.1 seconds;

the maximum arc time is 24 hours, preferably 15 min;

the difference between the voltage variation threshold value and the voltage variation measured over 0.1 seconds is at least 3 V, preferably at least 1 V, and/or the difference between the current variation threshold value and the current variation value measured over 0.1 seconds is at least 25 A, preferably at least 5 A;

the number of strikes performed by the electrode and the arc time of the electrode are permanently counted and are stored in memory;

it is carried out automatically by a welding robot or a programmable controller;

replacement of the eroded electrode with a fresh electrode in step c) is carried out automatically by an automated electrode changer; and

it includes the step of communicating the information about the state of the electrode by means of a display or a computer link to a production control operator or system.

The invention also relates to an automated or robotic arc welding installation comprising:

a welding torch with a non-consumable electrode carried by a robotic arm or by a support frame;

measurement means for determining at least one wear-indicating parameter chosen from: i) the number of strikes performed by the electrode in question; ii) the arc time of said electrode; and iii) the strike time;

storage means for storing in memory at least one preset reference value corresponding to a maximum number of strikes, a maximum arc time and a maximum strike time;

data processing means co-operating with the measurement means and the storage means, in order to compare the value of at least one of the wear-indicating parameters determined by the measurement means with at least one preset reference value held by the storage means; and

electrode replacement means capable of automatically replacing the eroded electrode with a fresh electrode when the processing means determine that the value of at least one of the wear-indicating parameters is equal to or exceeds at least said preset reference value.

Depending on the case, the installation of the invention may comprise one or more of the following features:

the measurement means are voltage and current sensors, for example a Hall-effect probe and a voltmeter, or any other sensor for carrying out the same function;

the storage means are specific to the controller and/or the robot, for example a memory card, incremental counter or any other element for carrying out the same function;

the data processing means are programs specific to the controller and/or the robot; and

the electrode replacement means comprise an automated electrode changer capable of grasping the eroded electrode within the torch and replacing it with a fresh electrode.

According to the method of the invention, certain parameters representative of the state of wear of the electrode are therefore monitored, namely:

the number of strikes performed by the electrode in question right from when it was inserted into the TIG torch, that is to say right from its first use;

the arc time of said electrode, that is to say the total time during which an electric arc has been generated by the electrode; and

the strike time i.e. the time needed to establish an electric arc upon being struck.

By monitoring at least one parameter, but preferably several parameters simultaneously, it is possible for any wear of the electrode to be reliably detected.

Strike Time

The strike time may be monitored by the current generator or by the robot or auxiliary equipment. A long strike time is a direct result of degraded electrode geometry and/or composition reducing its emissivity and therefore making breakdown and the establishment of the arc more difficult.

The strike time of a fresh electrode is about 0.1 seconds. Thereafter, longer strike times (of around several seconds) are generally the result of greater or lesser wear of the electrode.

This may be observed and then measured, in order to deduce electrode wear information therefrom. The maximum strike time threshold must be chosen to be close to the end of life of the electrode, but such that the electrode can still carry out the welding.

Arc Time

Most welding generators or welding robots at the present time count the arc time of an electrode. This parameter may therefore be used to execute a regular change of the electrode without involving an operator.

To decide the maximum permissible arc time before any electrode change, an empirical procedure may for example be carried out, by performing welding tests with a series of several electrodes, under the standard conditions for using them, and by counting the arc times obtained for each of them. This makes it possible to obtain a maximum arc time that may serve as reference time. However, it is not desirable to use only this parameter, as it cannot by itself always prevent a premature electrode change.

Number of Strikes

As stated in the above paragraph, most welding generators or robots count the number of strikes made by an electrode. The maximum number of strikes may be determined empirically for a given welding application. As in the case of the arc time, it is not desirable to use only this parameter, although it does constitute a simple parameter to monitor, and therefore to give preference to. It is also the main parameter monitored within the context of the present invention. Preferably, the number of strikes and possibly the strike time and/or the arc time will therefore always be monitored.

In specific cases, the results given in the following table have been found empirically for the lifetime of a fresh electrode before failure.

TABLE

| Application | Number of strikes | Welding time |
|---|---|---|
| Hot-dip galvanized steel; | 240 | 240 min |
| Thickness: 1.5 mm; fusion welding | | |
| lines with CuSi3 wire; | | |
| ARCAL 10 (Ar, H₂) gas | | |
| (L = 1 m; V_{w} = 1 m/min) | | |
| Hot-dip galvanized steel; | 255 | 15 min |
| Lap joints; | | |
| Thickness: 0.8 mm; | | |
| CuSi3 wire; | | |
| ARCAL 10 (Ar/H₂) gas | | |
| (L = 50 mm; V_{w} = 0.8 m/min) | | |
| Carbon steel; | 1000 | 500 min |
| Thickness: 2 mm | | |
| (L = 50 cm; V_{w} = 1 m/min) | | |
| Aluminium; Thickness: 1.5 mm; | 320 | 60 min |
| AlSi wire; | | |
| ARCAL 1 (argon) gas | | |
| (L = 50 mm; V_{w} = 0.25 m/min) | | |

The ARCAL™ gas range is available from L'AIR LIQUIDE.

The above thicknesses denote the thickness of the assembled material; L denotes the length of the assembled bead; and V_{w} denotes the welding speed.

Apart from the three abovementioned main parameters, other parameters may also be taken into account for detecting the wear of an electrode or for increasing the precision of this detection, thereby reducing the risk of premature replacement. In this regard, mention may be made of monitoring the voltage (U) and the current (I).

This is because, in practice, arc instabilities caused by wear of the electrode are manifested by variations in arc length, and therefore rapid voltage variations. In the case of modem generators, the current is regulated constantly, but in the case of old-style generators with a dipping characteristic, the phenomenon will also cause current instability. These variations may be measured by means of a sensor and suitable measurement electronics. This data may be processed by filtering and then calculation, in order to obtain information about the amplitude of variation, its frequency or other resulting parameters. It should be noted that, for this specific case, measurements of the variations must be limited in time. This is because they must be carried out within quite a short period of time, in order to avoid all variations induced by deformations of the welded part, geometry of the welded part and movements of the weld pool. This therefore implies carrying out a measurement in for example 0.1 seconds. As mentioned above, the maximum permissible voltage and current variations may be determined empirically.

Thanks to the explanations given above, the invention will be more clearly understood through the following illustrative figures:

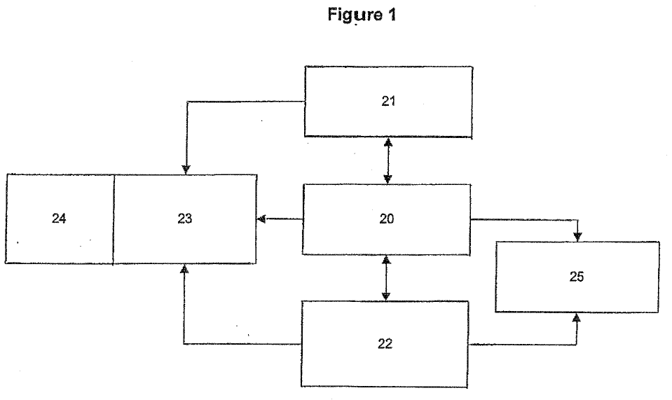

FIG. 1 is a block diagram of a welding cycle with electrode wear detection according to the invention;

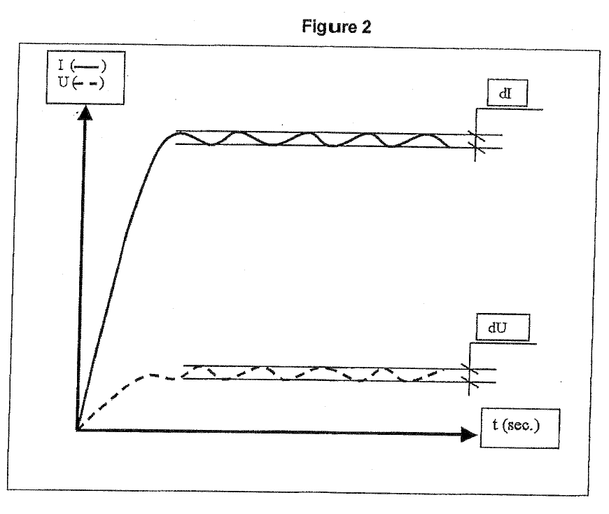

FIG. 2 is a diagram of the TIG welding voltage and current, measuring the variations in the signals of an electrode in a good state;

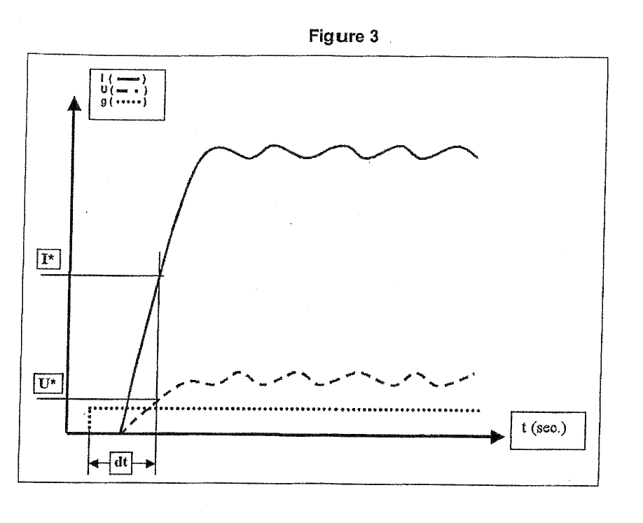

FIG. 3 is a diagram of the TIG welding voltage and current, measuring the strike time as a function of the current and voltage thresholds; and

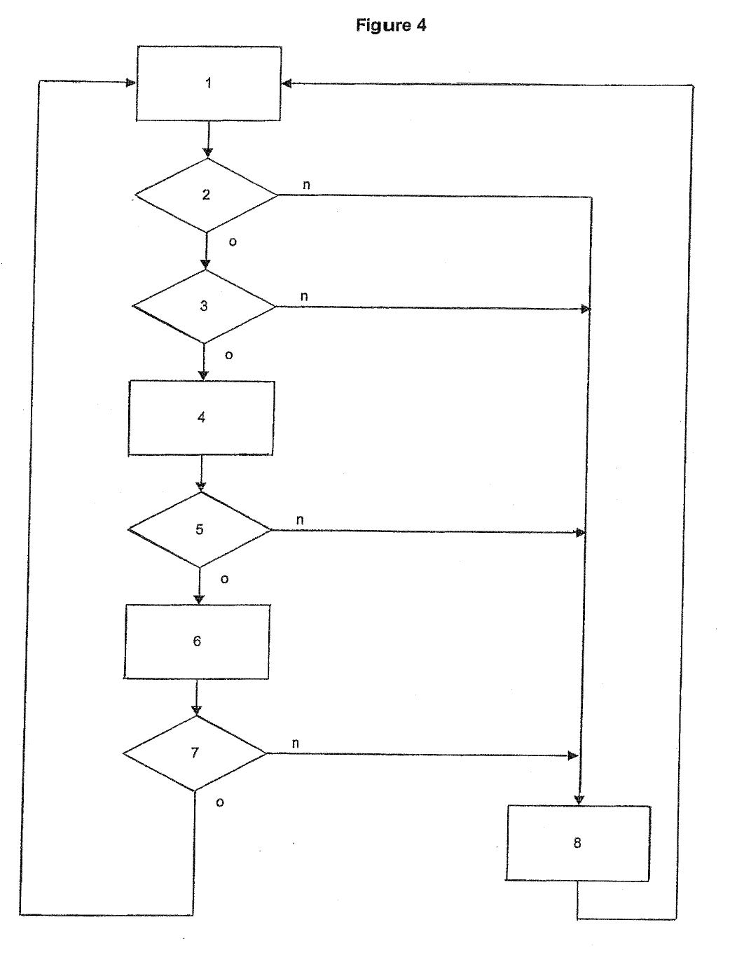

FIG. 4 is a diagram of the architecture of a TIG welding installation with an electrode changer incorporating the method of the invention.

Management of the welding cycle with electrode wear detection and possible electrode replacement may be implemented, for example, according to the block diagram shown in FIG. 4.

A TIG arc welding cycle usually implements a succession of operations: arc striking, actual welding, and arc extinction, this cycle being carried out with an arc welding torch provided with a non-consumable tungsten electrode.

According to the method of the invention shown schematically in FIG. 4, just before a new welding cycle is started (at 1) or after a welding operation has been carried out, the electrode wear parameters are checked so as to determine whether the electrode has to be changed (yes) or not (no).

To do this, the number of strikes performed with the electrode in question, during the previous welding cycles, is measured and then compared (at 2) with a maximum number-of-strikes reference value, for example 1000 strikes on steel.

If this measured number exceeds the maximum reference value, then the start of an electrode change phase may be carried out (at 8).

It is particularly useful and advantageous according to the invention to measure the number of strikes performed with the electrode in question, since this is a relatively easy parameter to monitor and measure. The number of strikes constitutes an essential monitoring parameter of the method of the invention.

Otherwise, the arc time, measured during the previous welding cycles, is then compared (at 3) with a maximum arc-time reference value, for example 4 hours.

As previously, when this measured arc time exceeds the maximum arc-time reference value, the electrode may be replaced (at 8) by a fresh electrode.

Otherwise, if neither the number of strikes nor the arc time exceed their set admissible maximum values, then a new strike may be performed (at 4). In parallel, the strike time needed to produce said strike is measured and this is compared (at 5) with a reference value.

As previously, if this strike time exceeds the maximum reference value, then the electrode may be replaced (at 8) after the welding operation.

Otherwise, the welding of the part or parts to be welded is carried out normally (at 6), while measuring, during welding, the welding voltage U and the welding current I.

Once the weld has been produced, a check is made (at 7) to see whether voltage and/or current variations during the welding were beyond set limits. If such is the case, here again, the electrode may be replaced (at 8).

In the absence of such variations and if the admissible maximum value has been exceeded, a new welding cycle is begun (at 1) since the electrode is still deemed to be usable and does not need to be replaced or sharpened.

Of course, the diagram shown in FIG. 4 is purely illustrative and in no way limiting. Moreover, it may comprise only some of the steps shown in this figure or it may also include additional steps for checking the state of wear of the electrode, which steps have not been shown in said figure.

FIG. 2 is an example of a typical graph of the arc current (I) and the arc voltage (U) (plotted on the y-axis) during a TIG arc welding operation, showing the variations (dI) in the welding current (I) as a function of the welding time (t) (plotted on the x-axis).

In the example shown in FIG. 2, the “dI” value indicates the variation in intensity for a smooth current and the value “dU” indicates the voltage variation in the steady state, that is to say after the arc has been struck and has stabilized. These variations are measured and calculated, for example from minimum and maximum current and voltage values in the observed sequence.

FIG. 3 is an example of a typical graph of the arc current (I) and the arc voltage (U) (plotted on the y-axis) during a TIG arc welding operation, showing the current (I*) and voltage (U*) thresholds as a function of the welding time (t) (plotted on the x-axis), and also the strike time (dt).

In the example shown in FIG. 3, the time indicated “dt” is the strike time between the command (trigger voltage g) given to the welding generator and the establishment of the welding current (current relay signal). The value “I” indicates the steady-state current and the value “U” indicates the steady-state voltage, that is to say after striking and stabilizing the arc. These levels are measured, calculated and compared for example with threshold values, which may for example be 10 volts in the case of U* and 50 amps in the case of I*.

The invention relates to the automated detection of the instant when an eroded electrode has to be replaced with a fresh electrode, in particular the tungsten electrode of the TIG welding torch described in document EP-A-1 459 831, so as to allow an automatic electrode change device, or electrode changer, to be put into operation.

As shown schematically in FIG. 4, the detection device and/or method may be controlled by a robot 21 equipped with the TIG torch or by a programmable controller 23 specific to the electrode changer 24. This may have the advantage of a completely autonomous system independent of the type of robot.

U and I may be measured directly in the welding current generator 20 or in auxiliary equipment 25, while the number of strikes and the strike time and/or the arc time may be counted in the robot 21.

The rest of the welding system 22 comprises the torch, the beam and the wire pay-out. An imaging system, for example a digital camera or any analogue image processing system may be added in order to determine the geometry, and therefore the state of wear of the electrode. For this purpose, a camera may also be incorporated into the changer presented below.

The electrode changer 24 is controlled by a programmable controller 23 incorporating an “intelligent” electrode change cycle based on automatic monitoring of one or more parameters representative of the actual state of wear of the electrode at a given instant, as explained above.

It should be noted that other secondary parameters exist, which may be monitored and used to detect the wear of the electrode, in combination with the above parameters, namely, in particular: any rupture of the arc, by measuring the generator current; irregularity in the welding result, for example detected by a camera viewing system; and analysis of an acoustic signal of the arc noise.

1. Automated method for detecting the wear of a non-consumable electrode of an arc welding torch and for automatically replacing or remachining said electrode when it is eroded with a fresh electrode, in which method the following steps are carried out:
a) the number of strikes performed by the electrode in question, and possibly at least one wear-indicating parameter chosen from the arc time of said electrode and the strike time for establishing the arc, is measured or counted during welding;
b) the value of at least one of the wear-indicating parameters determined in step a) is compared with at least one preset respective reference value; and
c) the eroded electrode is replaced with a fresh or sharpened electrode when the value of at least one of the wear-indicating parameters is equal to or exceeds at least said preset respective reference value.

2. Method according to claim 1, characterized in that several of said indicating parameters are determined and compared in step a) and the electrode is replaced when several of said indicating parameters exceed their preset respective reference values.

3. Method according to claim 1, characterized in that:
in step a), the electrical current and/or voltage generated by said electrode over a given welding time is also determined;
in step b), the measured current and/or voltage variations are compared with preset current and/or voltage variation threshold values; and
in step c) the electrode is replaced when
the value of at least one of the wear-indicating parameters is equal to or exceeds the preset reference value or
at least one of the voltage and/or current values exceeds one of the preset voltage and/or current threshold values.

4. Method according to claim 1, characterized in that the maximum number of strikes is set at 10 000 strikes, preferably 200 strikes.

5. Method according to claim 1, characterized in that the maximum strike time is 5 seconds, preferably 0.1 seconds.

6. Method according to claim 1, characterized in that the maximum arc time is 24 hours, preferably 15 min.

7. Method according to claim 1, characterized in that the difference between the voltage variation threshold value and the voltage variation measured over 0.1 seconds is at least 3 V, preferably at least 1 V, and/or the difference between the current variation threshold value and the current variation value measured over 0.1 seconds is at least 25 A, preferably at least 5 A.

8. Method according to claim 1, characterized in that the number of strikes performed by the electrode and the arc time of the electrode are permanently counted and are stored in memory.

9. Method according to claim 1, characterized in that it is carried out automatically by a welding robot or a programmable controller.

10. Method according to claim 1, characterized in that replacement of the eroded electrode with a fresh electrode in step c) is carried out automatically by an automated electrode changer.

11. Method according to claim 1, characterized in that it includes the step of communicating the information about the state of the electrode by means of a display or a computer link to a production control operator or system.

12. Automated or robotic arc welding installation comprising:
a welding torch with a non-consumable electrode carried by a robotic arm or by a support frame;
measurement means for determining at least one wear-indicating parameter chosen from: i) the number of strikes performed by the electrode in question; ii) the arc time of said electrode; and iii) the strike time;
storage means for storing in memory at least one preset reference value corresponding to a maximum number of strikes, a maximum arc time and a maximum strike time;
data processing means co-operating with the measurement means and the storage means, in order to compare the value of at least one of the wear-indicating parameters determined by the measurement means with at least one preset reference value held by the storage means; and
electrode replacement means capable of automatically replacing the eroded electrode with a fresh electrode when the processing means determine that the value of at least one of the wear-indicating parameters is equal to or exceeds at least said preset reference value.

13. Installation according to claim 12, characterized in that:
the measurement means are voltage and current sensors, for example a Hall-effect probe and a voltmeter, or any other sensor for carrying out the same function;
the storage means are specific to the controller and/or the robot, for example a memory card, incremental counter or any other element for carrying out the same function;
the data processing means are programs specific to the controller and/or the robot; and
the electrode replacement means comprise an automated electrode changer capable of grasping the eroded electrode within the torch and replacing it with a fresh electrode.

14. Method according to claim 2, characterized in that:
in step a), the electrical current and/or voltage generated by said electrode over a given welding time is also determined;
in step b), the measured current and/or voltage variations are compared with preset current and/or voltage variation threshold values; and
in step c) the electrode is replaced when
the value of at least one of the wear-indicating parameters is equal to or exceeds the preset reference value or
at least one of the voltage and/or current values exceeds one of the preset voltage and/or current threshold values.

15. Method according to claim 2, characterized in that the maximum number of strikes is set at 10 000 strikes, preferably 200 strikes.

16. Method according to claim 3, characterized in that the maximum number of strikes is set at 10 000 strikes, preferably 200 strikes.

17. Method according to claim 2, characterized in that the maximum strike time is 5 seconds, preferably 0.1 seconds.

18. Method according to claim 3, characterized in that the maximum strike time is 5 seconds, preferably 0.1 seconds.

19. Method according to claim 2, characterized in that the maximum arc time is 24 hours, preferably 15 min.

20. Method according to claim 3, characterized in that the maximum arc time is 24 hours, preferably 15 min.
